(19) United States
(12) Patent Application Publication
(10) Pub. No.: US 2003/0007171 A1
(43) Pub. Date: Jan. 9, 2003

(54) Document production management in a distributed environment

(76) Inventors: Shell Sterling Simpson, Boise, ID (US); Garth Frederick Schmeling, Boise, ID (US); Kenneth Lee Oakeson, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/901,974

(22) Filed: Jul. 9, 2001

(51) Int. Cl. G06F 3/12; G06F 13/00; G06F 15/00

(52) U.S. Cl. 358/1.15; 358/1.14; 710/19; 709/229

(57) ABSTRACT

A method for providing queue management and production device status in a distributed environment. One embodiment involves generating a queue interface having user accessible controls for managing production data held in a queue and presenting that queue interface to a client. A status interface is then generated to the client for a production device selected through the queue interface. In a second embodiment a queue interface is generated and presented to a client. Once the production data is delivered to a production device, a status interface for that production device is generated and delivered to the client.

### FIELD OF THE INVENTION

The present invention is directed to a method and system for electronic document production. More particularly, the invention is directed to a method and system for mediating access to production devices in a distributed environment.

### BACKGROUND OF THE INVENTION

In a basic desktop computing environment, a printer or other production device is connected directly to a computer. Production devices include printers; finishers such as a binder, sorter, or folder; e-mail clients; facsimile devices; web servers; and electronic data storage devices. However, production devices are not limited to those listed but may include any device capable of electronically or physically saving, displaying, formatting, or transferring a target document. To produce a document, a user either opens or creates an electronic document using a word processor or other application. The user then issues a production request for a selected production device. A driver, specific to the selected production device—a printer in this example—generates a user interface allowing the user to select options for formatting the document. Among others, these options can include the number of copies, print resolution, specific paper source and output bins. With the desired production options selected, the driver formats the production request into a specialized series of commands directing the printer to produce the document on one or more sheets of paper. To add a new production device, the user simply connects the new device and installs the new driver for that device on the computer.

In a more complex environment, the computer and production devices are components of a larger network of electronic devices. A number of network users can share a common production device such as a printer. Using device management software application, a system administrator is able to manage and limit access to that printer. While new printers and other production devices can be easily connected to the network, drivers for those devices must be individually installed on each client computer that accesses the new device. As updates for the device drivers become available, the updates must also be installed on each client computer.

With the ever-expanding resources provided by the Internet, document production has taken a dramatic step forward. Becoming more autonomous, production devices are being designed to connect directly to and communicate over the Internet. Rather than being controlled by a device driver installed on a desk-top computer or separate print server, these new production devices contain their own programming.

In one new system, a client computer, utilizing a web browser rather than a particular device driver, accesses a web server embedded in a production device such as a printer. Representing that device on the network, the embedded web server allows the device to be connected directly to the network rather to another device such as a desktop computer. When accessed by a browser, the embedded web server returns a web page containing controls for formatting and printing a selected document. With the document and desired format options selected, the browser returns the document and the user's formatting instructions to the embedded web server, which, in turn, self-manages production of the document on the device.

In another new system, the client computer, using a browser, accesses a print service—a web site hosted by a server computer. The print service presents the user with a selection of printers from which to choose. The browser returns the user's printer selection along with the location of the components of the document to be printed. For example, the text of the document may be located in one location on the network while the color graphics for a cover page may be located elsewhere. The print service then directs the web browser to a server embedded in or otherwise representing the selected printer. That web server returns a web page allowing the user to select formatting options for the document. With the options selected, the print service compiles the document's components and delivers them along with the selected formatting options to the web server representing the selected production device.

Generally, these new systems are designed to eliminate the need for centralized device management. However, as with conventional document production, it is desirable, if not essential, in some cases to provide some centralized control over a group of production devices. Centralized control is useful to provide temporary storage for production data sent to each device and to track the production status for one or more documents. For example, a professional printing business may provide access to a group of production devices over the Internet. Production devices such as printers are capable of printing one document at a time. Where multiple requests are simultaneously directed to a single production device, the business may desire to temporarily store each successive request in a central queue releasing the request one at a time as the production device becomes available. Moreover, that business may desire to provide its system administrator or clients with controls over and information concerning their requests when held in the queue as well as information concerning the status of the production device selected. Consequently, what is needed is a method for centrally managing production requests capable of providing information relating to the current status of a given production device within these new systems for document production.

### SUMMARY OF THE INVENTION

Accordingly, the present invention is directed to a method for providing queue management and production device status in a distributed environment. One embodiment involves generating a queue interface having user accessible controls for managing production data held in a queue and presenting that queue interface to a client. A status interface is then generated to the client for a production device selected through the queue interface. In a second embodiment a queue interface is generated and presented to a client. Once the production data is delivered to a production device, a status interface for that production device is generated and delivered to the client.

### DESCRIPTION OF THE DRAWINGS

FIG. 1 is a schematic representation of a computer network that includes several client devices, a server device, and several production devices.

FIG. 2 is a block diagram of the network of FIG. 1 in which the invented mediation service is embodied in a program running on the server device according to one embodiment of the present invention.

FIG. 3 is a block diagram further illustrating the logical components of the mediation service according to one embodiment of the present invention.

FIG. 4 is a flow diagram illustrating the document production process provided by the mediation service according to one embodiment of the present invention.

FIG. 5 is an exemplary screen view of an interface for selecting production options.

FIG. 6 is an exemplary screen view of an interface for managing the queue while providing status information for a particular production device.

### DETAILED DESCRIPTION OF THE INVENTION

Glossary:

Program: An organized list of electronic instructions that, when executed, causes a device to behave in a predetermined manner. A program can take many forms. For example, it may be software stored on a computer's disk drive. It may be firmware written onto read-only memory. It may be embodied in hardware as a circuit or state machine that employs any one of or a combination of a number of technologies. These technologies may include, but are not limited to, discrete logic circuits having logic gates for implementing various logic functions upon an application of one or more data signals, application specific integrated circuits having appropriate logic gates, programmable gate arrays (PGA), field programmable gate arrays (FPGA), or other components.

Client-Server: A model of interaction between two programs. For example, a program operating on one network device sends a request to a program operating on another network device and waits for a response. The requesting program is referred to as the “client” while the device on which the client operates is referred to as the “client device.” The responding program is referred to as the “server,” while the device on which the server operates is referred to as the “server device.” The server is responsible for delivering requested information back to the client. In any given network there may be multiple clients and multiple servers. A single device may contain programming allowing it to operate both as a client device and as a server device. Moreover, a client and a server may both operate on the same device.

Interface: The junction between a user and a computer program providing commands or menus through which a user communicates with a program. The term user in this context represents generally any person or mechanism desiring to communicate with the program. For example, in the client-server model defined above, the server usually generates and delivers to a client an interface for communicating with a program operating on or controlled by the server device. Where the server is a web server, the interface is a web page. The web page when displayed by the client device presents a user with controls for selecting options, issuing commands, and entering text. The controls displayed can take many forms. They may include push-buttons, radio buttons, text boxes, scroll bars, or pull-down menus accessible using a keyboard and/or a pointing device such as a mouse connected to a client device. In a non-graphical environment, the controls may include command lines allowing the user to enter textual commands.

Introduction: In a new model for network document production, a user identifies and provides a self-representing production device access to a target document. A target document is an electronic document selected for production. A target document may comprise two or more components. For example, the document's text may be stored in one electronic file while the document's graphics are stored in another. Each component may be stored on a different network device. The term store should be taken liberally. A network device that “stores” a component may not actually store anything, but will be capable of servicing requests related to the “stored” item. To identify the target document, a user need only locate the target document's components and provide instructions on accessing those components. A self-representing production device has the ability, without the aid of a second device, to communicate over a network and produce a target document upon request. For example, a production device such as a conventional printer is incapable of self-representation and must be connected to and controlled by a second device such as a desktop computer or a print server. A self-representing device typically contains a production server facilitating network communication and managing document production.

To utilize a self-representing device, a user sends a request to access (an “access request”) a production server operating on the device selected to produce the target document. The production server returns a user interface allowing the user to select production options for the target document. A production device such as a conventional printer usually provides only one service, printing. Other production devices provide multiple services. A single device may be able to provide printing, copying, scanning, and facsimile services. For each service, there may exist a number of production options. For example, when printing a document, options can include duplexing, landscape or portrait orientation, and finishes such as stapling or sorting. The instructions for accessing the target document along with selected production options are returned to the production server, which, in turn, retrieves the target document and manages its production in accordance with the selected options.

It is expected that by providing a mediation service, embodiments of the invention will allow centralized management of the production requests while providing information relating to the current status of a given production device within this new model.

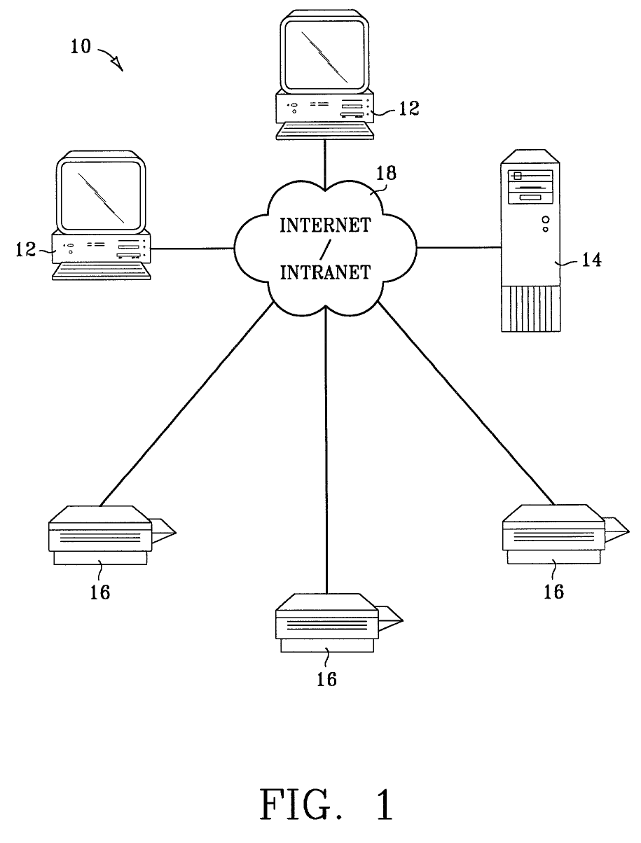

Although the various embodiments of the invention disclosed herein will be described with reference to the computer network 10 shown schematically in FIG. 1, the invention is not limited to use with network 10. The invention may be implemented in or used with any computer system in which it is necessary or desirable to produce electronic documents. The following description and the drawings illustrate only a few exemplary embodiments of the invention. Other embodiments, forms, and details may be made without departing from the spirit and scope of the invention, which is expressed in the claims that follow this description.

Referring to FIG. 1, network 10 represents generally any local or wide area network in which a variety of different electronic devices are linked. Network 10 includes client devices 12, typically personal computer workstations. However, client device 12 represents generally any device, a personal digital assistant for example, capable of displaying a user interface. Network 10 also includes server device 14 and production devices 16. While shown as printers, production devices 16 represent any production device present on network 10. While capable of other functions, server device 14 need only facilitate communication between client devices 12 and production devices 16.

Communication link 18 interconnects client devices 12, server 14, and production devices 16. Communication link 18 represents generally a cable, wireless, or remote connection via a telecommunication link, an infrared link, a radio frequency link, or any other connector or system that provides electronic communication between devices 12, 14, and 16. Communication link 18 may represent an intranet, an Internet, or a combination of both. The path followed by link 18 between devices 12, 14, and 16 in the schematic view of FIG. 1 represents the logical communication path between these devices, not necessarily the physical path between the devices. Devices 12, 14, and 16 can be connected to the network at any point and the appropriate communication path established logically between the devices.

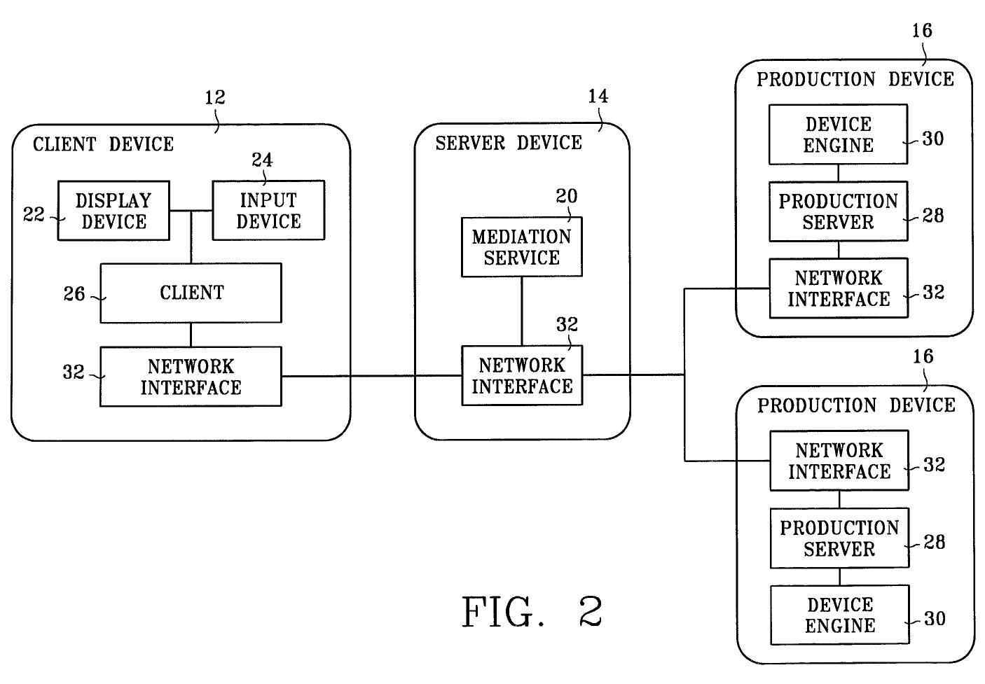

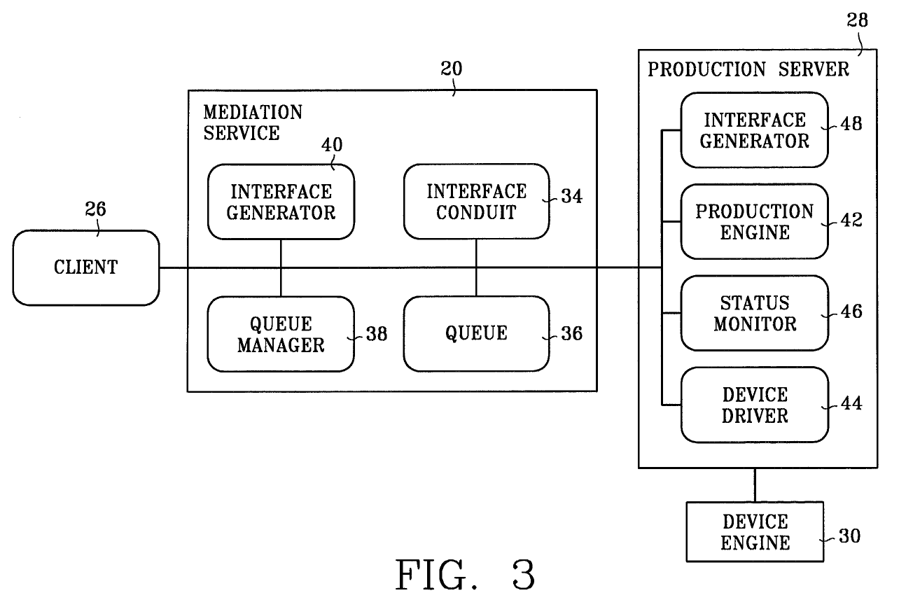

Components: The logical components of one embodiment of the invented document production system will now be described with reference to the block diagrams of FIGS. 2 and 3. In FIG. 2, the invention is embodied in software or other programming, described in more detail below, labeled mediation service 20 operating on server device 14. Mediation service 20 represents generally programming capable of mediating network communication between client devices 12 and production devices 16. While illustrated as operating on server device 14, mediation service 20, or components thereof, may just as well operate on client 12, one or more production devices 16, or any other network device. Client device 12 provides a mechanism for presenting a user with one or more interfaces for managing document production on production devices 16. Client device 12 usually includes a monitor or other suitable display device 22 and a keyboard and/or a pointing device such as a mouse or other suitable input device 24. Client 26 is a program for causing display device to display a desired interface and for delivering instructions to mediate access to service 20. Consequently, while client device 12 is illustrated as a device separate from server device 14 and production devices 16, the function of client device 12, specifically client 26, can be incorporated into any network device capable of providing a user interface, which may include devices 14 and/or 16. While FIG. 2 illustrates mediation service 20 operating on server device 14, it may just as well operate on production devices 16 or client device 12. Production devices 16 are self-representing, each containing a production server 28. Production servers 28 represent generally any programming capable of providing an interface for selecting production options and then managing production of a document using production options selected through that interface.

Each production device 16 also includes device engine 30 which represents generally hardware and/or programming for producing a target document. In the case of a laser printer, device engine 30 is a print engine including all the necessary hardware and programming required deposit toner in the form of a target document on one or more sheets of paper. In the case of a facsimile device, device engine 30 includes the necessary hardware and programming required to electronically reproduce and transmit a target document over a telephone line. To facilitate network communication between devices 12, 14, and 16, each includes network interface 32.

Referring now to FIG. 3, mediation service 20 includes interface conduit 34, queue 36, queue manager 38, and interface generator 40. Interface conduit 34 represents generally any programming capable of acquiring an access request generated by client 26 and directed to a particular production device 16, acquiring a production interface from production server 28 controlling production device 16, and returning the production interface to client 26 as required. A production interface, usually displayed by client 26, includes controls for selecting production options for a target document. The production interface may also include controls for identifying a particular document as a target document. Interface conduit 34 may also acquire from production server 28 a status interface for production device 16. A status interface, also usually displayed by client 26, provides information concerning the current status of the particular production device 16. This information can include the status of the current target document being produced as well as the status of the production device's consumables—for example—paper and toner in a laser printer.

Queue 36 represents generally a temporary electronic holding bin for production data directed to a busy or malfunctioning production device 16. Production data, usually provided by client 26, represents generally production options selected for a target document as well as the target document itself or instructions for accessing the target document. Queue manager 38 represents generally any programming capable of administering the production data within queue 36. Upon receipt of production data from client 26 for a target document, queue manager 38 places the production data in queue 36. Queue manager 38 tracks the status of production data and provides interface generator 40 with the information required to generate a queue interface. The term queue interface, represents generally, an interface having controls for displaying the status of production data held in queue 36 as well as controls for manipulating the production data in queue 36. As production device 16 becomes available, queue manager 38 releases production data from queue 36 for one target document at a time.

Still referring to FIG. 3, production server 28 includes production engine 42, device driver 44, status monitor 46, and interface generator 48. Production engine 42 represents generally any programming capable of receiving production data, retrieving, if required, a specified target document, and generating a production plan using the production data. Device driver 44 represents generally any programming capable of translating the production plan into a specialized set of commands used by device engine 30 to produce the target document. Interface generator 48 is also responsible for generating a production interface for the particular production device 16.

Status monitor 46 represents generally programming and/or hardware for monitoring production device 16. It is envisioned that status monitor 46 will observe the current level of consumable, if any, in production device 16 as well as the progress of device engine 30. Using information gathered by status monitor, interface generator 48, generates a status interface.

It is envisioned that interface generators 40 and 48 will, function at least in part as web servers and that client 26 will be a web browser. A web server is a program that hosts documents, commonly referred to as Web pages, for remote retrieval over a network such as the World Wide Web. Usually, a web server functions as software operating on a network computer, but can be firmware embedded into production devices 16. Web pages can be delivered in a number of formats including, but not limited to, HTML (Hyper-Text Markup Language) and XML (eXtensible Markup Language). The web pages may be generated on demand using server side scripting technologies including, but not limited to, ASP (Active Server Pages) and JSP (Java Server Pages). A web browser is a client program for requesting and displaying web pages.

Using HTML (hyper-text mark up language) and/or another internet language, interface generators 40 and 48 each create a requested interface in the form of a web page having an associated network address. The network address is usually in the form of an URL (Uniform Resource Locator) or IP (Internet Protocol) address. Beneficially, this allows cross platform communication. For example, production servers 28 may be functioning under one operating system such as Linux® while client device 12 may be running Microsoft® Windows®.

The block diagrams of FIGS. 1-3 show the architecture, functionality, and operation of one implementation of mediation service 20. If embodied in software, each block may represent a module, segment, or portion of code that comprises one or more executable instructions to implement the specified logical function(s). If embodied in hardware, each block may represent a circuit or a number of interconnected circuits to implement the specified logical function(s).

Also, mediation service 20 can be embodied in any computer-readable medium for use by or in connection with an instruction execution system such as a computer/processor based system or other system that can fetch or obtain the logic from the computer-readable medium and execute the instructions contained therein. A “computer-readable medium” can be any medium that can contain, store, or maintain mediation service 20 for use by or in connection with the instruction execution system. The computer readable medium can comprise any one of many physical media such as, for example, electronic, magnetic, optical, electromagnetic, infrared, or semiconductor media. More specific examples of a suitable computer-readable medium would include, but are not limited to, a portable magnetic computer diskette such as floppy diskettes or hard drives, a random access memory (RAM), a read-only memory (ROM), an erasable programmable read-only memory, or a portable compact disc.

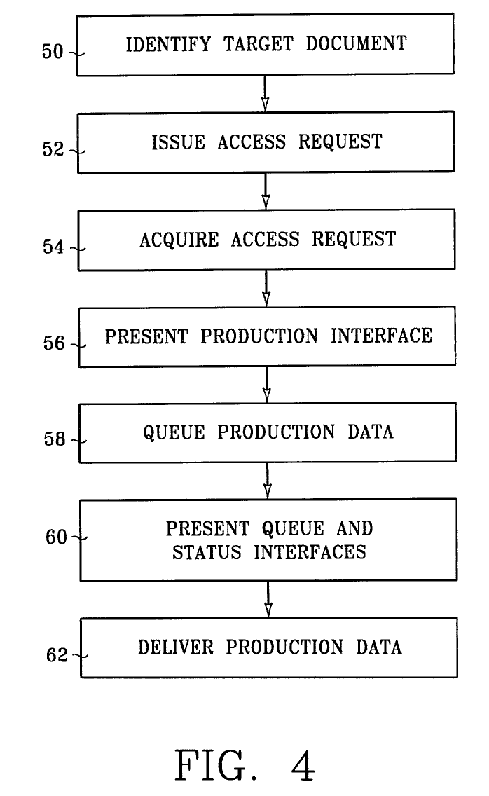

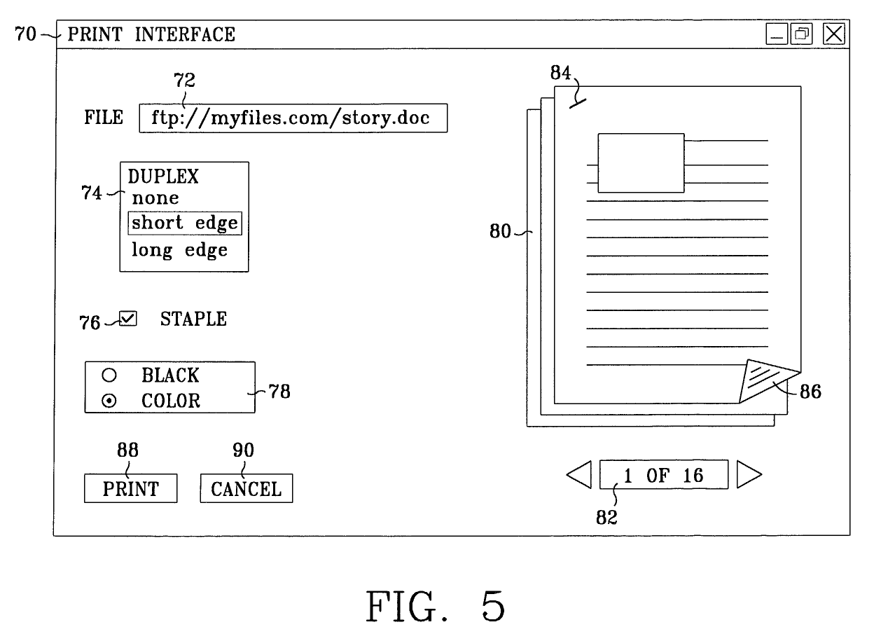

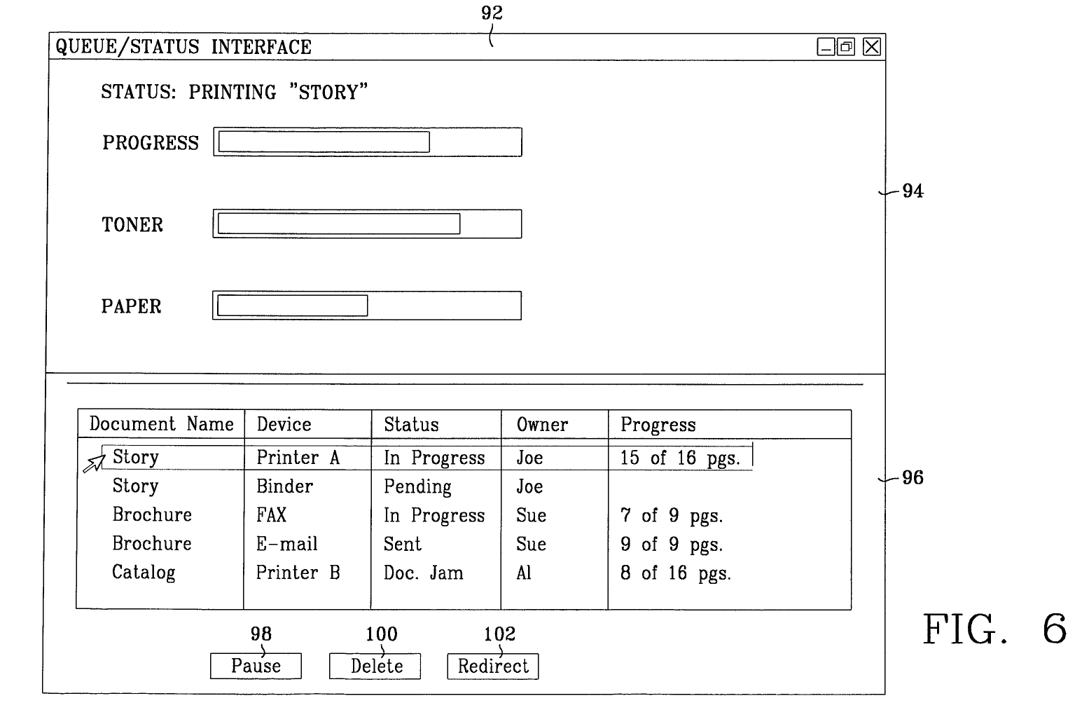

Operation: The operation of mediation service 20 will now be described with reference to the flow diagram of FIG. 4 and the exemplary screen views of FIGS. 5 and 6. FIG. 4 provides an example of the steps taken to produce a document using mediation service 20. FIG. 5 illustrates screen view of a production interface for a printer. FIG. 6 illustrates a screen view of a queue interface and a status interface displayed together.

Beginning with FIG. 4, using client 26, a target document is identified (step 50). Client 26 issues an access request for one production device 16 (step 52). Interface conduit 34 acquires the access request (step 54) and presents client 26 with a production interface (step 56). Queue manager 38 places production data selected through the production interface in queue 36 (step 58). Upon request Interface generator 40 presents client 26 with a queue interface and a status interface (step 60). In the meantime, queue manager 38 delivers production data from queue 36 to production device 16 as it becomes available (step 62).

As discussed above, it is envisioned that client 28 will be a web browser. When issuing an access request in step 52, client 26 browses to the network address assigned to the selected production device 16. This address may take the form of an URL (Uniform Resource Locator) or an IP (internet Protocol) address. Acquiring in step 54 may be accomplished in a number of ways. Interface conduit 34 might monitor and intercept network communication directed to production device 16. It is envisioned, however, that when client 26 browses to the network address for the selected production device 16, production server 28 for the selected device 16 will return a web page redirecting client 26 to mediation service 20. The production interface presented to client 26 in step 56 includes instructions identifying the selected production device 16 as the ultimate recipient of production data selected through the production interface. For example, the web page for a particular production device is associated with the URL—http://printer.company.company.com.” Mediation service 20 is accessed through the URL—http://mediation.company.com. When issuing an access request, client 28 browses to http://printer.company.com. The production server 28 for the selected device 16 returns a web page redirecting client 28 to the URL—http://mediation.company.com/ref?device=http://printer.company.com. In this manner, mediation service 20 is able to later access the URL for the selected production device 16 which is indicated following the “ref?device=” portion of the above URL.

In a second example, a directory service is used. The term directory service embodies generally any programming capable of providing a listing of available production devices and instructions for accessing those devices. The directory service may be located on server device 14 but need only be accessible by client 26. To issue an access request, client 26 browses to the directory service, which returns an interface for selecting a production device. When production device 16—access to which is controlled by mediation service 20—is selected, the directory service redirects client 28 to mediation service 20 providing mediation service 20 with the identity of the selected production device 16. For example, the interface produced by the directory service may include a link to each production device. For production device 16 controlled by mediation service 20, that link is a link to mediation service 20 with a reference to the address of production device 16. Using the exemplary URLs from above, the link would be “<a href=“http://mediation.company.com/ref?device=http://printer.company.com”>.”

The delivery of production data in step 62 may be accomplished in a similar manner. The web page for a selected production device 16 may include instructions directing client 26 to deliver chosen production data directly to mediation service 20. Although initially received and held by mediation service 20 in queue 36, that production data would include instructions specifying the selected production device 16, thus, providing queue manager 38 with the ultimate destination of the production data.

It may be desirable or necessary in some cases to present client 26 with more than one interface in step 56 before all production data can be queued and later delivered in steps 58 and 62. For example, the number of production options available for a selected production device 16 may require more controls than can be displayed on one screen. The device 16 may provide advanced production options that users generally do not access. In these situations, step 56 involves providing client 26 with an initial interface. The initial interface includes controls or other means for requesting each subsequent interface. For example, once a user has selected the desired production options on the initial interface, the user may select a control to access a subsequent interface for selecting advanced production options. It is envisioned, then, that the initial and each subsequent interface provided to client 26 will include instructions to deliver production data directly to mediation service 20 along with instructions providing queue manager 38 with the ultimate destination of the production data.

FIG. 5 illustrates a screen displaying a production interface for a printer as presented in step 56 of FIG. 4. In this example, interface 70 includes control 72 for identifying the target document. Controls 74-78 allow the user to select options such as duplexing, stapling, and color printing. Control 80 provides a print preview for the document allowing the user to visualize the document before printing. Where the document contains multiple pages, control 82 to scroll through and preview each page. Print preview control 80 also reflects selected production options. Icon 84 shows that staple control 76 has been selected. Icon 86 shows that duplex control 74 has been selected. With the desired options selected, the user can then select print control 88 or may select cancel control 90.

FIG. 6 illustrates a screen displaying combined queue/status interface 92. In this example, interface 92 includes status frame 94 and queue management frame 96. Queue management frame 96 displays the status of each set of production data held in queue 34 as well as user accessible controls for directing how queue manager 40 manipulates that production data. Here, queue management frame 96 displays the status of three sets of production data—Story, Brochure, and Catalog. Story is to be produced on Printer A and then bound. Brochure is to be delivered via fax and electronic mail. Catalog is to be produced on Printer B. Frame 96 includes manipulation controls 98, 100, and 102 for controlling each set of production data. For example, frame 96 shows that Printer B is malfunctioning. Highlighting catalog and then selecting redirect control 102 allows the production data to be delivered to a functioning printer. Status frame 94 displays the current status of a production device 16 selected in queue management frame 96. In this example, status frame 94 is for a “Printer A” providing information on the progress of printing the target document as well as data concerning the printer's consumables.

As discussed earlier with reference to FIG. 3, interface generator 40 is responsible for generating or otherwise providing a queue interface presented in queue management frame 96. Interface generator 48 is responsible for generating or otherwise providing the status interface presented in status frame 94. It is envisioned that combined interface 92 will be a framed web page. A framed web page is one that divides the browser's display area into two or more sections or frames. The actual content of each frame is not provided by the framed web page itself. Rather, the framed web page provides, for each frame, a network address for accessing a specified web page to be displayed in that frame.

It is expected then that interface generator 40 will also be responsible for generating combined interface 92. For queue management frame 96, interface generator 40 provides the network address for the queue interface. For status frame 94, interface conduit 34 acquires and interface generator 40 provides the network address for the status interface for the device 16 selected in queue management frame 96. As mentioned above, the production data for each target document may include the network address or other instructions identifying the production device 16 responsible for producing that document. It is expected then that the production data will also include the network address associated with the status interface for that production device. When a user selects, in queue management frame 94, production data directed to a different production device, interface conduit 34 acquires and interface generator 40 provides status frame 94 with the network address associated with the status interface for that production device.

In step 60, the queue and status interfaces may be presented to client 26 in alternative manners. For example, upon placement of production data in queue 36 in step 58, interface generator 48 generates and presents client 26 with the queue interface. Once queue manager 38 begins to deliver the production data to production device 16, interface conduit 34 acquires the status interface for production device 16, interface generator 40 presents the status interface to client 26. Where client 26 is a web browser, this may be accomplished by redirecting client 26 from the network address associated with the queue interface to the network address associated with the status interface. Initially, client 26 is presented with production interface 70, for example. Once all desired production data is selected, selecting print control 88 in FIG. 5, for example, redirects client 26 to the network address associated with the queue interface. Once production data is delivered out of queue 36, the programming of queue interface redirects client 26 to the network address of the status interface for production device 16.

Two approaches are envisioned for ensuring interface 92 presents current information. One approach would be to set a refresh interval on frames 94 and 96, which would cause browser to periodically retrieve and display an updated interface 92. Another approach would be to incorporate, within interface 92, executable content (such as a JAVA applet) capable of continually or periodically retrieve updated information from mediation service 20 and production server 28.

Although the flow chart of FIG. 4 shows a specific order of execution, the order of execution may differ from that which is depicted. For example, the order of execution of two or more blocks may be scrambled relative to the order shown. Also, two or more blocks shown in succession in FIG. 4 may be executed concurrently or with partial concurrence. All such variations are within the scope of the present invention. The screen displays of FIGS. 5 and 6 are exemplary only. There exist many possible layout and control configurations for interfaces that will allow a user to select available production options, manage production data, and view device status. FIGS. 5 and 6 each merely provide one example.

The present invention has been shown and described with reference to the foregoing exemplary embodiments. It is to be understood, however, that other forms, details, and embodiments may be made without departing from the spirit and scope of the invention, which is defined in the following claims.

What is claimed is:

1. A method for providing queue management and production device status in a distributed environment, comprising:
generating a queue interface having user accessible controls for managing production data held in a queue, the production data to be delivered to a production device;
presenting the queue interface to a client;
generating a status interface for the production device; and
presenting the status interface to the client.

2. The method of claim 1, further comprising managing the production data in the queue in accordance with instructions entered through the queue interface.

3. The method of claim 1, wherein the acts of generating the queue and status interfaces comprise generating the queue and status interfaces each in the form of a web page.

4. The method of claim 1, wherein the queue is capable of containing production data directed to more than one production device and wherein the acts of generating and presenting the status interface comprise generating and presenting the status interface for a production device selected through the queue interface.

5. The method of claim 1, wherein the acts of generating and presenting the status interface for the production device comprise generating and presenting the status interface once the production data is delivered to the production device.

6. The method of claim 1, wherein the act of presenting the queue and status interfaces comprise generating and presenting a combined queue/status interface.

7. The method of claim 6 wherein:
the act of generating the queue interface comprises generating the queue interface in the form of a web page;
the act of generating the status interface comprises generating the status interface in the form of a web page; and
the act of generating the combined queue/status interface comprises generating the combined queue/status interface in the form of a framed web page.

8. A method for mediating access to production devices, comprising:
acquiring an access request for a production device;
presenting to a client a production interface for the production device, the interface having user accessible controls for selecting production data;
placing in a queue production data selected through the production interface;
generating a queue interface having user accessible controls for managing the production data in the queue;
presenting the queue interface to a client;
generating a status interface for the production device; and
presenting the status interface to the client.

9. The method of claim 8, wherein the acts of generating the queue and status interfaces comprise generating the queue and status interfaces each in the form of a web page.

10. The method of claim 8, wherein the queue is capable of containing production data directed to more than one production device and wherein the acts of generating and presenting the status interface comprise generating presenting the status interface for a production device selected through the queue interface.

11. The method of claim 8, wherein the acts of generating and presenting the status interface for the production device comprise generating and presenting the status interface once the production data is delivered to the production device.

12. The method of claim 8, wherein the acts of generating and presenting the queue and status interfaces comprise generating and presenting a combined queue/status interface.

13. The method of claim 12 wherein:
the act of generating the queue interface comprises generating the queue interface in the form of a web page;
the act of generating the status interface comprises generating the status interface in the form of a web page; and
the act of generating the combined queue/status interface comprises generating the combined queue/status interface in the form of a framed web page.

14. A computer program product for providing queue management and production device status in a distributed environment, the product comprising a computer useable medium having computer readable instructions thereon for:
generating a queue interface having user accessible controls for managing production data held in a queue, the production data to be delivered to a production device;
presenting the queue interface to a client;
generating a status interface for the production device; and
presenting the status interface to the client.

15. The product of claim 14, further comprising instructions for managing the production data in the queue in accordance with instructions entered through the queue interface.

16. The product of claim 14, wherein the queue is capable of containing production data directed to more than one production device and wherein the instructions for generating and presenting the status interface comprise instructions for generating presenting the status interface for a production device selected through the queue interface.

17. The product of claim 14, wherein the instructions for generating and presenting the status interface for the production device comprise instructions for generating and presenting the status interface once the production data is delivered to the production device.

18. The product of claim 14, wherein the instructions for presenting the queue and status interfaces comprise instructions for generating and presenting a combined queue/status interface.

19. The product of claim 18 wherein:
the instructions for generating the queue interface comprise instructions for generating a queue interface in the form of a web page;
the instructions for generating the status interface comprise instructions for generating the status interface in the form of a web page; and
the instructions for generating the combined queue/status interface comprises generating the combined queue/status interface in the form of a framed web page.

20. A computer program product for mediating access to production devices, the product comprising a computer useable medium having computer readable instructions thereon for:
acquiring an access request for a production device;
presenting to a client a production interface for the production device, the interface having user accessible controls for selecting production data;
placing in a queue production data selected through the production interface.
generating a queue interface having user accessible controls for managing the production data in the queue;
presenting the queue interface to a client;
generating a status interface for the production device; and
presenting the status interface to the client.

21. The product of claim 20, wherein the instructions for generating the queue and status interfaces comprise instructions for generating the queue and status interfaces each in the form of a web page.

22. The product of claim 20, wherein the queue is capable of containing production data directed to more than one production device and wherein the instructions for generating and presenting the status interface comprise instructions for generating presenting the status interface for a production device selected through the queue interface.

23. The product of claim 20, wherein the instructions for generating and presenting the status interface for the production device comprise instructions for generating and presenting the status interface once the production data is delivered to the production device.

24. The product of claim 8, wherein the instructions for generating and presenting the queue and status interfaces comprise instructions for generating and presenting a combined queue/status interface.

25. The product of claim 24 wherein:
the instructions for generating the queue interface comprise instructions for generating the queue interface in the form of a web page;
the instructions for generating the status interface comprise instructions for generating the status interface in the form of a web page; and
the instructions for generating the combined queue/status interface comprise instructions for generating the combined queue/status interface in the form of a framed web page.

26. In a computer network, a system for providing queue management and production device status, the system comprising:
one or more production devices, each production device having a production server operable to generate a status interface for the particular production device;
a client operable to display a user interface;
a mediation service in electronic communication with the client and the production device or devices, the mediation service operable to generate a queue interface having user accessible controls for managing production data to be delivered to one or more of the production devices and held in a queue, present the queue interface to the client, and present to the client the status interface for a particular production device.

27. The system of claim 26, wherein the mediation service includes a queue manager operable to manage production data in the queue in accordance with instructions provided through the queue interface.

28. The system of claim 26, wherein the mediation service includes an interface generator operable to present to the client the status interface for a production device identified through the queue interface.

29. The system of claim 28, wherein the interface generator is further operable to generate and present the queue and status interfaces in the form of a combined queue/status interface.

30. The system of claim 29, wherein:
at least one of the production servers includes a web server operable to generate the status queue in the form of a web page associated with a first network address; and
the interface generator of the mediation service functions, at least in part, as a web server operable to generate the queue interface in the form of a web page associated with a second network address and to present the combined queue/status interface in the form of a framed web page having a first frame referencing the first network address and a second frame referencing the second network address.

31. The system of claim 26, further comprising an interface generator operable to present to the client the status interface for a production device once production data is delivered from the queue to that device.

32. In a computer network, a system for providing queue management and production device status, the system comprising:
one or more production devices each having a production server operable to generate a status interface and manage production of a target document for a particular production device;
a client operable to issue an access request for a selected production device and to display one or more interfaces;
a queue for storing production data;
an interface conduit in electronic communication with the client and the production server or servers, the interface conduit operable to acquire the access request, present to the client a production interface for the production device to which the request is directed, and to place in the queue production data selected through the production interface;
a queue manager operable to deliver production data from the queue to the production server for the production device to which that production data is to be delivered; and
an interface generator operable to generate and present to the client a queue interface and to present to the client the status interface for a particular production device.

33. The system of claim 32, wherein the interface generator is further operable to present to the client the status interface for a production device identified through the queue interface.

34. The system of claim 33 wherein the interface generator is further operable to present the queue and status interfaces in the form of a combined queue/status interface.

35. The system of claim 34, wherein:
the interface generator and at least one of the production servers each function, at least in part, as a web server;
the production server being further operable to generate the status interface in the form of a web page associated with a first network address; and
the interface generator being further operable to generate the queue interface in the form of a web page associated with a second network address and to present the combined queue/status interface in the form of a framed web page referencing the first and second network addresses.

36. The system of claim 32, wherein the interface generator is further operable to present the status interface for that production device once that production data is delivered.

37. The system of claim 36, wherein:
the interface generator and at least one of the production servers function at least in part as web servers;
the production server being further operable to generate the status interface in the form of a first web page; and
the interface generator being further operable to generate the queue interface in the form of a second web page.

38. The system of claim 32, wherein the queue manager is further operable to manage production data in the queue in accordance with instructions provided through the queue interface.
